(19) United States
(12) Patent Application Publication
(10) Pub. No.: US 2024/0390918 A1
(43) Pub. Date: Nov. 28, 2024

(54) SEPARATION DISC, SEPARATION DISC STACK, AND CENTRIFUGE HAVING SAID SEPERATION DISC STACK

(71) Applicant: GEA WESTFALIA SEPARATOR GROUP GMBH, Oelde (DE)

(72) Inventors: Jens UEDING, Beckum (DE); Anna KEMNER, Warendorf (DE)

(21) Appl. No.: 18/688,408

(22) PCT Filed: Aug. 19, 2022
(86) PCT No.: PCT/EP2022/073228

§ 371 Date: Mar. 1, 2024

(30) Foreign Application Priority Data
Sep. 2, 2021 (DE) 20 2021 104 728.3

(51) Int. Cl. B04B 7/14; B04B 1/08

(52) U.S. Cl. CPC B04B 7/14; B04B 1/08

(57) ABSTRACT

A separation disc for a centrifuge is intended to be arranged in a separation disc stack in a drum interior of a drum of the centrifuge for clarifying or separating a mixture of substances. The separation disc comprises a main body, which is in the shape of a truncated cone, is created in a forming method and has a smaller diameter and a larger diameter, as well as an inner surface and an outer surface, and at least one or more spacers. Radially outer projections are distributed circumferentially in the region of the spacers on the larger diameter of the main body and each projection is arranged in a line and/or in an extension of the outer surface of the main body of the separation disc.

### BACKGROUND AND SUMMARY OF THE INVENTION

Exemplary embodiments of the present invention relate to a separation disc, a stack of such separation discs, and a centrifuge with such a separation disc stack.

Centrifuges with a separation disc—also known as separators—can be designed as separators or clarifiers. Separators are designed to separate liquid mixtures consisting of two more fluid phases and a solid phase into these phases. Clarifiers are used to separate solids from a fluid phase.

In the centrifuge, the liquid mixture to be processed is fed into the drum via a centric inlet pipe. From here, the liquid mixture enters a distributor, which accelerates the mixture to the drum speed and feeds it into a separation chamber in the drum. The liquid mixture rises through riser channels—which are located inside or on the outer edge of a separation disc stack—into a separation disc stack. Here, annular gaps/spaces are created for separating or clarifying the liquid mixture by means of conical separation discs arranged one above the other, which are provided with spacer tabs arranged radially on them.

The spacer tabs are designed with different axial thicknesses depending on the product. The riser channels are usually designed as circular holes or slotted holes and placed in a separation zone.

In wastewater treatment applications with solids, the separation disc stack is used only or possibly also for separating the solids.

For the separation discs used for clarification, the separating zone on the outer diameter of the disc results in riser regions on the outside of the outer diameter of the disc. Accordingly, such separation discs can be provided with recesses on the outer circumference, which form the riser channels or riser regions in the separation disc stack. Such separation discs forming, for example, semi-circular riser channels are also referred to in technical terminology as “externally slotted” separation discs.

For separator applications in which two liquids of different densities are separated from each other and possibly also solids, the riser channels are usually located further inside the separation disc stack. This provides sufficient clarification surface for both the specifically lighter and the specifically heavier liquid. Most of the incoming suspension flows through the riser channel into the separation disc stack. The specifically heavy liquid is discharged at the outer disc diameter.

The irregularities in the gap flow caused by the sludge chamber flow can also be reduced by additional rib arrangements outside the disc pack and the resuspension of any solid particles present can also be reduced here. These ribs are mounted in the drum so that they cannot rotate, i.e., they rotate at drum speed and their position in relation to the channels of the distributor is fixed, as shown in DE 32 01 866 C2 and DE 10 2004 042 888 A1.

The liquid mixture is fed to the disc insert through the riser channels in the separation zone. The separated solids are spun outwards by the centrifugal force and discharged at discharge openings in the solids chamber, which extends from the outer disc diameter to the largest inner drum diameter. The specifically lighter liquid leaves the disc insert at the inner diameter via an outlet. The specifically heavier liquid is directed upwards at the separator on the outer diameter of the disc insert and guided to a further outlet, e.g., via a separation disc.

A structurally simple and cost-effective implementation of flow optimization on the outer diameter of the separation disc stack is desirable in order to increase the separation efficiency of the separation disc stack.

Accordingly, a separation disc is created for a centrifuge, in particular for a separator, wherein the separation disc is provided to be arranged in a separation disc stack in a drum interior of a drum of the centrifuge for clarifying or separating a mixture of substances, wherein the separation disc has a frustoconical shell-like main body that is created in a forming process and has a smaller diameter d and, relative thereto, a larger diameter D, and an inner surface and an outer surface and has at least one or more spacers which is designed in the form of a tab. A plurality of radially outer projections are arranged circumferentially distributed on the large diameter D of the main body in the region of the spacers and the respective projection is arranged in a line, in particular a straight line, and/or in a radial extension of the outer surface of the main body of the separation disc. The line is preferably a straight line. The extension can extend straight or it can protrude outwards at an angle to the radial direction. The respective projection preferably has the same taper angle relative to the axial axis of the separation disc as the frustoconical shell-like main body of the separation disc.

In order to form a segmentation of the riser channels in the separation disc stack, it is now advantageously no longer necessary to introduce additional ribs outside the disc pack into the separating space of the drum. Instead, the advantageous segmentation of the riser channels is created by the projections and the spacers in the form of tabs at or on the separation disc, which are also applied to the projections.

A particular effect of the segment-like channels formed in this way on the outer edge of the separation disc stack is an improved feed or channeling of the suspension or product to be separated into the separation disc stack and thus into the gap formed between two main bodies of superimposed separation discs in the separation disc stack, as well as a reduction in resuspension due to disruptive flows induced by sludge or solids.

According to a particularly preferred embodiment variant of the invention, it may be provided that the arrangement of the projections on the circumference of the main body of the separation disc in the region of the large diameter D is made with the same pitch as the arrangement of the spacers. This results in pronounced segment-like channels on the outer circumference of the separation disc stack due to the superimposed separation discs.

According to another particularly preferred embodiment variant of the invention, it may be provided that the respective projection has the same taper angle relative to the axial axis of the separation disc as the frustoconical shell-like main body of the separation disc. This results in a separation disc stack with segmentation by the spacers also in the region of the projection.

According to a further particularly preferred embodiment variant of the invention, it may be provided that segment-like zones are formed by the projections in the region of the large diameter D of the main body between the projections.

Due to the segment-like zones on the separation disc, which are formed by the projections in interaction with the spacers or tabs, the flow profile on the large diameter D of the separation disc stack is advantageously more homogeneous and stationary. The suspension or the product is thus guided more specifically into a separating segment created by the projections and the spacers in the form of tabs and can make better use of the available clarifying surface of the respective separation disc. The separation efficiency of the centrifuge can be advantageously increased due to the better utilization of the clarifying surface.

Furthermore, according to a preferred embodiment of the invention, it may be provided that semi-circular cutouts, for example, are arranged circumferentially distributed on the large diameter D of the frustoconical shell-like main body. The cutouts are simple in design and easy to implement in terms of production technology.

According to a further preferred embodiment variant of the invention, it can also be provided that the cutouts are each located approximately in the middle of the respective segment-like zone. Depending on the flow behavior of the suspension to be separated in the separation disc stack, it may also be advantageous to arrange the cutouts in the right or left region of the segment-like zone. As a result, the flow profile at the cutouts of the separation disc is advantageously more homogeneous and stationary.

Furthermore, according to a further preferred embodiment of the invention, it may be provided that each individual spacer has a continuous length, which corresponds approximately to the length of the surface line M on the outer surface of the frustoconical main body plus the length of the respective projection. In this way, an effective segmentation of the flow in the separation disc stack is brought about in a structurally simple and thus advantageous manner.

According to a further particularly preferred embodiment variant of the invention, it may be provided that the spacers are arranged in the form of tabs at an angle α to the surface line M. As a result, the position of the spacers on the main body of the respective separation disc can be designed to be flow-optimized depending on the requirements for the respective product to be separated.

According to a further particularly preferred embodiment of the invention, it may be provided that the projections are arranged at an angle α to the surface line M. As a result, the position of the projections on the main body of the respective separation disc can also be designed to be flow-optimized depending on the requirements for the respective product to be separated.

Furthermore, according to a preferred embodiment of the invention, it may be provided that in the region of the projection, the respective tab follows the angular alignment of the projection, so that the respective tab extends in line with the projection. In this way, an effective segmentation of the flow in the separation disc stack is brought about in a structurally simple and thus advantageous manner.

According to a further preferred embodiment variant of the invention, it can also be provided that in the region of the projection, the respective tab is angled by the complementary angle β of the angle α, so that the respective tab has a first section and a second section. This provides a simple design option for flexibly adapting the respective tab to the respective requirements.

Furthermore, according to a further preferred embodiment of the invention, it may be provided that in the region of the projection the respective tab follows the angular orientation of the projection, so that the second section of the respective tab extends in a line with the projection.

According to a further particularly preferred embodiment variant of the invention, it may be provided that the respective projection is integrally formed on the main body or is attached to the main body by a joining process. This creates possibilities for realizing the projection that are simple in terms of design and easy to implement in terms of production technology.

Furthermore, according to a preferred embodiment of the invention, it may be provided that the main body of the separation disc is preferably produced by a spinning process. This ensures that the separation disc is manufactured using a proven forming process.

According to a further preferred embodiment variant of the invention, it may also be provided that the main body of the separation disc is made of a metallic material, preferably steel. This ensures that the separation disc can safely withstand the forces acting on it during operation of the centrifuge over the long term.

Furthermore, according to a further preferred embodiment of the invention, it may be provided that the separation disc has a driver geometry on the smaller diameter d of the frustoconical main body. In this way, a secure positive connection between the distributor shaft of the centrifuge and the respective separation disc is simply created by design.

According to a further particularly preferred embodiment variant of the invention, it may be provided that the cross-sectional geometry of the spacer is rectangular, trapezoidal rectangular, rectangular with rounded corners, semi-elliptical or semi-oval. This advantageously results in various possibilities for manufacturing the spacer as well as a flow-optimized design.

### BRIEF DESCRIPTION OF THE DRAWING FIGURES

In the following, the invention is described in more detail with reference to the figures by means of exemplary embodiments. The invention is not limited to these exemplary embodiments but can also be implemented in other ways or equivalently within the scope of the claims. The figures show as follows:

FIG. 1: shows a schematic representation of a centrifuge in full section;

FIG. 2a): shows plan view of an exemplary embodiment of a separation disc according to the invention;

FIG. 2b) shows a 3D view of the separation disc from FIG. 2a) according to the invention;

FIG. 3a): shows a plan view of a further exemplary embodiment of a separation disc according to the invention;

FIG. 3b) shows a 3D view of the separation disc from FIG. 3a);

FIG. 4a): shows a plan view of a further exemplary embodiment of a separation disc according to the invention;

FIG. 4b) shows a 3D view of the separation disc from FIG. 4a);

FIG. 5a): shows a plan view of a further exemplary embodiment of a separation disc according to the invention; and

FIG. 5b) shows in a 3D view the separation disc from FIG. 5a).

### DETAILED DESCRIPTION

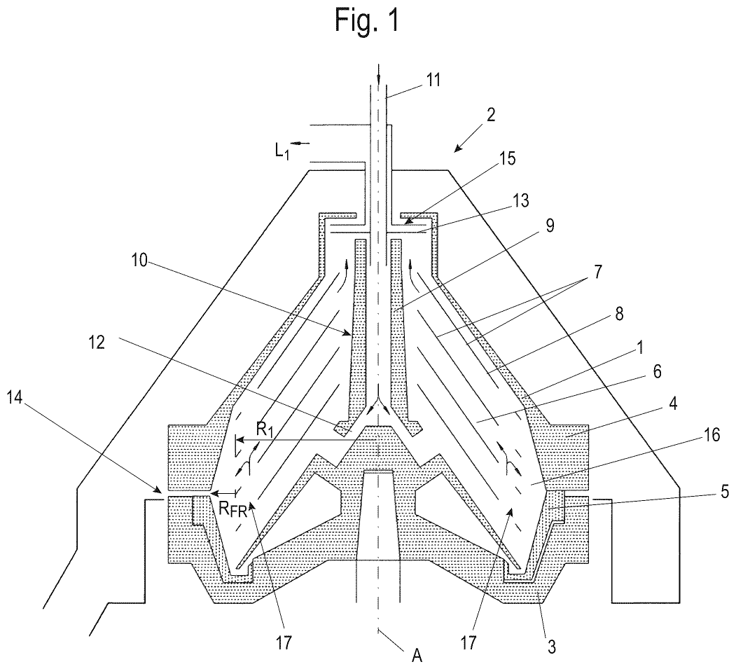

FIG. 1 shows a rotatable drum 1 of a centrifuge 2, which is designed here as a separator for sewage applications with solids with a vertical axis of rotation A. In addition to the drum 1, the centrifuge 2 has—in a manner known per se—further components, not all of which are shown here, such as a control computer, a drive motor for rotating the drum, a hood, a frame, a solids catcher, etc.

The drum 1, which can be rotated by a self-driven and rotatably mounted drive spindle, is preferably—but not necessarily—designed for continuous operation, i.e., the continuous and not batchwise processing of a product.

The drum 1 consists of a lower part 3 and an upper part 4. A piston slide 5 can be inserted into the lower part 3 in order to optionally open solids discharges 14. These can also be designed as non-closable nozzles for continuous discharge.

In the drum 1, which is preferably designed for continuous operation, here in the internally conical or here even double-conical shaped drum 1, a separation disc stack 7 consisting of several separation discs 8 is arranged in a drum interior 6. An annular sludge or solids chamber 16 is formed in the drum 1 between an inner wall of the lower part 3 of the drum 1 and a radial outer side of the separation disc stack 7.

The separation discs 8 can be arranged on a distributor shaft 9 of a distributor 10 or attached to the distributor shaft 9 coaxially to the axis of rotation A. A feed pipe 11 is used to feed a product to be processed. The feed pipe 11 is designed here as a stationary element that does not rotate during operation. It extends concentrically to the axis of rotation A into the drum 1.

According to FIG. 1, it protrudes into the drum 1 from above in a preferred—but not mandatory—design. However, it can also extend into the drum 1 from below. The product emerging from the free end of the feed pipe 11 flows into the essentially radially extending distribution channels 12 of the distributor 10 and is rotated in these as a result of the rotations of the rotating drum 1 or accelerated in the circumferential direction.

The distribution channels 12 open into the drum interior 6 with the separation disc stack 7. In the drum interior 6—also known as the centrifugal chamber—a product is clarified from solids and separated into one, two, or more liquid phases of different densities. In the example shown in FIG. 1, a product is clarified from solids and a liquid phase L1 in the drum interior 6. One or more drains for liquid phases are used to discharge the at least one liquid phase L1, here purely by way of example a liquid phase L1.

The liquid draining radially inwards from the separation disc stack 7 flows into a paring disc chamber 15, which rotates with the drum 1 and is designed as the upper, terminating part of this drum 1. A paring disc 13 is arranged in the paring disc chamber 15. The paring disc 13 works according to the operating principle of a centripetal pump and accordingly conveys the liquid phase L1 to the outside. However, the liquid outlets from the drum 1 can also be designed in a different way.

Inlet and outlet lines into and out of drum 1 can be of open, semi-closed, hydrohermetic or hermetic design (see “Industrial Centrifuges”, Volume II, Chapter 6.9 by Werner H. Stahl).

The solids collect in the solids chamber 16. The solids are ejected out of the drum 1 through circumferentially distributed, radially extending outlet openings 14, preferably in the region of the largest radius/circumference of the drum 1.

According to FIG. 1, the hydraulically actuatable piston slide 5 can be provided for the solids outlet in the lower part 3, with which the outlet openings 14 can be intermittently opened and closed again. The solids outlet can also be designed differently than shown here, e.g., in the form of outlet nozzles. It may also be possible to dispense with a solids outlet.

Alternatively, the separator can also be designed for separation applications, i.e., for centrifugal separation of two liquids in which solids can also be separated. Alternatively, it could also be designed for batch operation. In addition, the centrifuge could also be a solid drum screw centrifuge or decanter centrifuge, which has a separation disc stack 7 for further clarification of the liquid phase.

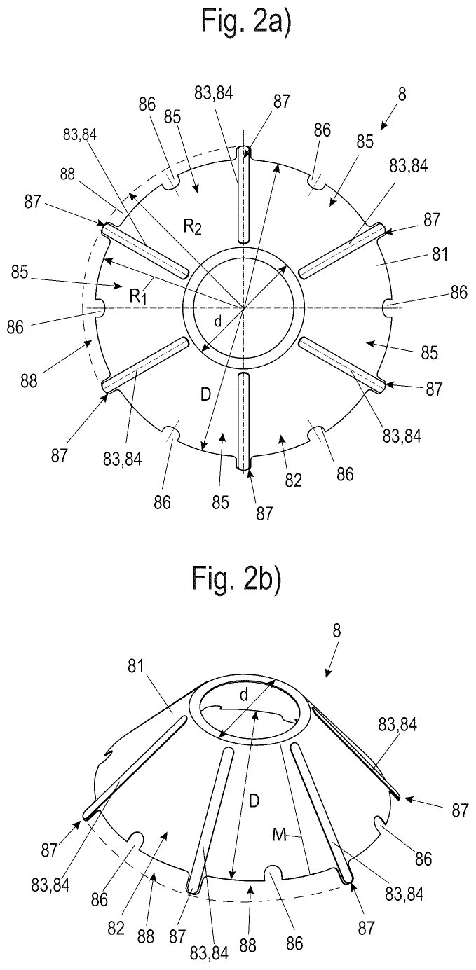

FIG. 2a shows a separation disc 8 according to the invention for the centrifuge 2, which is exemplarily designed here as a clearer (see FIG. 1). The separation disc 8 has a frustoconical shell-like main body 81. The main body 81 of the separation disc 8 is preferably made of a metallic material—preferably steel—by a forming process. This ensures that the separation disc 8 permanently withstands the forces acting on it during operation of the centrifuge 2.

The separation disc 8 can have a driver geometry (not shown here) on a smaller diameter d of the frustoconical main body 81. Such a driver geometry is part of a rotationally fixed positive connection between the respective separation disc 8 and the distributor shaft 9 (see FIG. 1), which corresponds geometrically to the driver geometry, is arranged coaxially to the axis of rotation A within the centrifugal chamber of the centrifuge 2 and onto which several separation discs 8 are fitted during the assembly of the drum 1 until an intended separation disc stack 7 has been formed.

Here, the separation disc 8 has several spacers 83 on an outer surface 82 of the main body 81. The spacers 83 can, for example, be placed on the main body 81 so that a further separation disc 8 rests with an inner surface on the spacers 83. In this way, a space or gap is created between two separation discs 8 in the separation disc stack 7, which is separated by the respective spacers 83 and thus segmented.

Alternatively, the spacers 83 can also be arranged on an inner surface of the main body 81. In a further alternative embodiment, the spacers 83 can be arranged both on the outer surface 82 and on the inner surface of the main body 81.

The cross-sectional geometry of the spacers 83 can, for example, be rectangular, trapezoidal rectangular, rectangular with rounded corners, semi-elliptical or semi-oval, or have another advantageous geometry. The cross-sectional geometry of the spacer 83 can also be asymmetrical.

In the exemplary embodiment of FIG. 2a and FIG. 2b, the spacers 83 are designed in the form of elongated tabs 84 arranged symmetrically to and along a surface line M or parallel to the surface line.

The term “surface line” refers to such a line, which is set up perpendicularly on two parallel tangents, wherein the tangents are each tangent to/touch the small diameter d of the frustoconical shell-like main body 81 and a large diameter D of the frustoconical shell-like main body 81.

The geometry of the spacers 83 on the main body 81 of the separation disc 8 can vary. Accordingly, differently shaped spacers 83 can also be arranged on the main body 81. The dimensions—for example, width, thickness, and length—of the spacers 83 on a separation disc 8 can also vary.

The cross-sectional geometry of the spacers 83 can also vary.

The tabs 84 and thus the spacers 83 are distributed here as an example in a uniform pitch on the circumference of the main body 81, here on the outer surface 82 of the main body 81. The spacers 83 can also be arranged in non-uniform pitch or variable pitch or in repeating—i.e., regular—pitch patterns or in non-repeating—i.e., irregular—pitch patterns on the circumference of the main body 81.

The spacers 83 and thus the tabs 84 are spaced apart here by gaps of the same length 85 between the tabs 84. The gaps 85 can also be of different lengths in the circumferential direction and/or of different sizes from tab 84 to tab 84. The tabs 84, which are arranged symmetrically to and along or parallel to the surface line M, can also vary in length.

On the large diameter D of the frustoconical shell-like main body 81, semi-circular cutouts 86 are arranged/formed here, for example, distributed around the circumference. The distribution of the cutouts 86 on the circumference can take place in an even pitch, as shown in FIG. 2b, alternatively the distribution of the cutouts 86 can also take place in an uneven—i.e., variable—pitch.

The cutouts 86 each form a type of riser channel 17 in the separation disc stack 7 consisting of separation discs 8 arranged one above the other. The respective riser channel 17 can extend parallel to the axis A of the centrifuge 2 or along a helical line around the axis A. The respective riser channel 17 is used for the ascent of the liquid phase L1.

In this respect, the separation disc 8 in FIGS. 2a and 2b is a separation disc 8 for clarification applications, in which the largest possible separation zone is provided for discharging the liquid phase L1 and, accordingly, the separation zone between the liquid phase L1 and the solid is located in the region of the large diameter D of the separation disc 8.

Projections 87 are also arranged circumferentially distributed on the large diameter D of the frustoconical shell-like main body 81. The respective projection 87 is designed in such a way that it is arranged in a line or in extension of the outer surface 82 of the main body 81 of the separation disc 8. In this respect, the respective projection 87 has the same conical angle relative to the axial axis of the separation disc as the frustoconical main body 81 of the separation disc 8.

In other words, the respective projection 87 is molded onto the main body 81 without a step to the main body or an angulation. In this case, the respective projection 87 can be integrally formed on the main body 81 or attached to the main body 81 by a joining process.

Furthermore, it may be provided that the projections 87 protrude into the solids chamber 16 of the drum 1 by 25% to 75% in relation to a distance R_{FR} between the radius R1 of the main body 81 of the separation disc 8 without projection 87 and the outer diameter of the solids chamber 16 in the region of the separation disc stack 7. Since the inner contour of the drum 1 is conical or even double-conical in this region, the value R_{FR} is not constant over the axial extension of the separation disc stack 7. This means that both the length of the respective projections can be designed differently and the distance between the respective projections and the outer diameter of the solids chamber can vary.

The projections 87 result in arcuate segment-like zones 88 in the region of the large diameter D of the main body 81 between the projections 87 in the circumferential direction. In this exemplary embodiment, the cutouts 86 are located approximately in the middle of the respective segment-like zone 88, as shown in FIG. 2a and FIG. 2b. Depending on the flow behavior of the suspension to be separated in the separation disc stack 7, it can also be advantageous to arrange the cutouts 86 in the right or left region of the segment-like zone 88.

In order to form a suitable segmentation of the riser channels in the separation disc stack 7, it is now advantageously no longer necessary to introduce additional rib bodies outside the separation disc stack 7 into the separating chamber 6 of the drum 1. Instead, the advantageous segmentation of the riser channels in the separation disc stack 7 is created by the projections 87 and the resulting segment-like zones 88, the cutouts 86 and the applied spacers 83 in the form of tabs 84 on or on the separation disc 8.

The effect of the riser channels or the segment-like zones 88 on the outer edge of the separation disc stack is an improved feed or channeling of the suspension or product to be separated into the separation disc stack and thus into the gap formed between two main bodies 81 of superimposed separation discs 8 in the separation disc stack 7, as well as a reduction in resuspension due to disruptive flows induced by sludge or solids. Due to the segment-like zones 88, the flow profile at the large diameter D of the separation disc stack 7 is advantageously more homogeneous and stationary. The suspension or the product is thus guided in a more targeted manner into a separation segment created by the spacers 83 in the form of tabs 84 and can make better use of the available clarifying surface of the respective separation disc 8. The separation efficiency of the centrifuge 2 can be advantageously increased due to the better utilization of the clarifying surface.

As shown in FIG. 2a and FIG. 2b, the arrangement of the projections 87 on the circumference of the main body 81 of the separation disc 8 in the region of the large diameter D can therefore be advantageously carried out with the same pitch as the arrangement of the spacers 83, which are designed here as tabs 84. As a result, the projections 87 are virtually an extension of the tabs 84. As described above, this is advantageous, but not mandatory.

Each individual spacer 83, which is designed here as a tab 84, can have a continuous length, which can correspond exactly or substantially to the length of the surface line M on the outer surface 82 of the frustoconical main body 81 plus the length of the respective projection 87.

The respective projection 87 has the same conical angle relative to the axial axis of the separation disc as the frustoconical shell-like main body 81 of the separation disc 8.

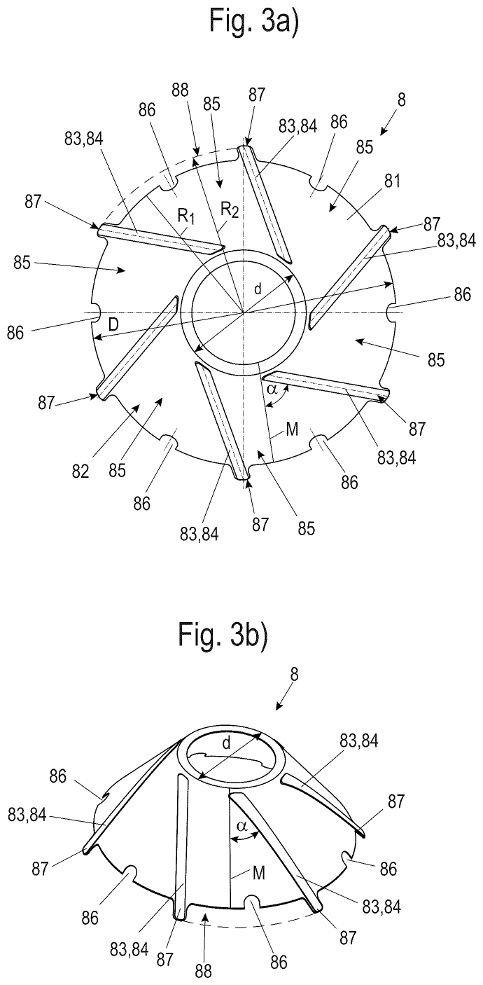

FIG. 3a and FIG. 3b show an embodiment variant of a separation disc 8 according to the invention. In this variant, too, the spacers 83 in the form of tabs 84 are applied to the outer surface 82 of the main body 81 of the separation disc 8 at an equal pitch on the circumference of the main body 81 of the separation disc 8. Deviating from the embodiment variant according to FIG. 2a and FIG. 2b, the spacers 83 in the form of tabs 84 are arranged at an angle α to the surface line M. The amount of the angle α is preferably between 10° and 60°, particularly preferably between 20° and 45°.

The tabs 84 are distributed here—analogous to the embodiment variant according to FIG. 2a and FIG. 2b—in an even pitch on the circumference of the main body 81, here on the outer surface 83 of the main body 81.

In the embodiment variant according to FIG. 3a and FIG. 3b, it is provided that the projections 87 are arranged at an angle α to the surface line M. In the region of the projection 87, the respective tab 84 follows the angular alignment of the projection 87, so that the respective tab 84 extends in a line with the projection 87. The angle α is preferably between 10° and 60°. This also applies to other embodiments where this angle occurs.

Each individual tab 84 has a continuous length here, which extends from the small diameter d of the main body 81 of the separation disc 8 to the large diameter D of the main body 81 of the separation disc 8 plus the length of the projection 87 arranged at an angle here.

The respective projection 87 has the same conical angle relative to the axial axis of the separation disc as the frustoconical shell-like main body 81 of the separation disc 8.

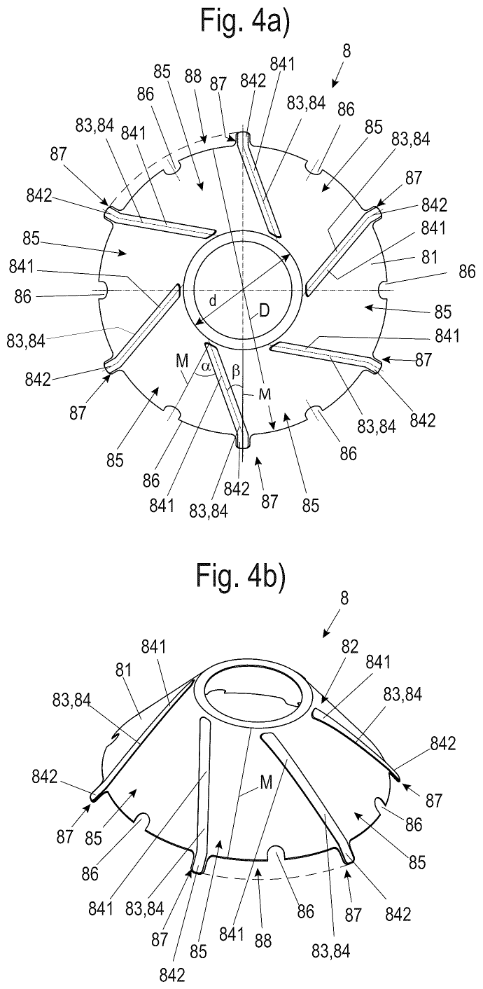

FIG. 4a and FIG. 4b show a further embodiment variant of a separation disc 8 according to the invention. In this variant, too, the spacers 83 in the form of tabs 84 are applied to the outer surface 82 of the main body 81 of the separation disc 8 at an equal pitch on the circumference of the main body 81 of the separation disc 8. Deviating from the embodiment variant according to FIG. 2a and FIG. 2b and analogous to the embodiment variant according to FIG. 3a and FIG. 3b, the spacers 83 in the form of tabs 84 are arranged at an angle α to the surface line M.

The tabs 84 are distributed here—analogous to the embodiment variant according to FIG. 2a and FIG. 2b—in a uniform pitch on the circumference of the main body 81, here on the outer surface 82 of the main body 81. Each individual tab 84 here has a continuous longitudinal extension, which extends from the small diameter d of the main body 81 of the separation disc 8 to the large diameter D of the main body 81 of the separation disc 8.

In the embodiment variant shown in FIG. 4a and FIG. 4b, it is also provided that the projections 87 are arranged along or parallel to the surface line M.

In the region of the projection 87, the respective tab 84 is therefore angled by the complementary angle β of the angle α, so that the respective tab 84 has a first section 841 and a second section 842.

The respective projection 87 has the same conical angle relative to the axial axis of the separation disc as the frustoconical shell-like main body 81 of the separation disc 8.

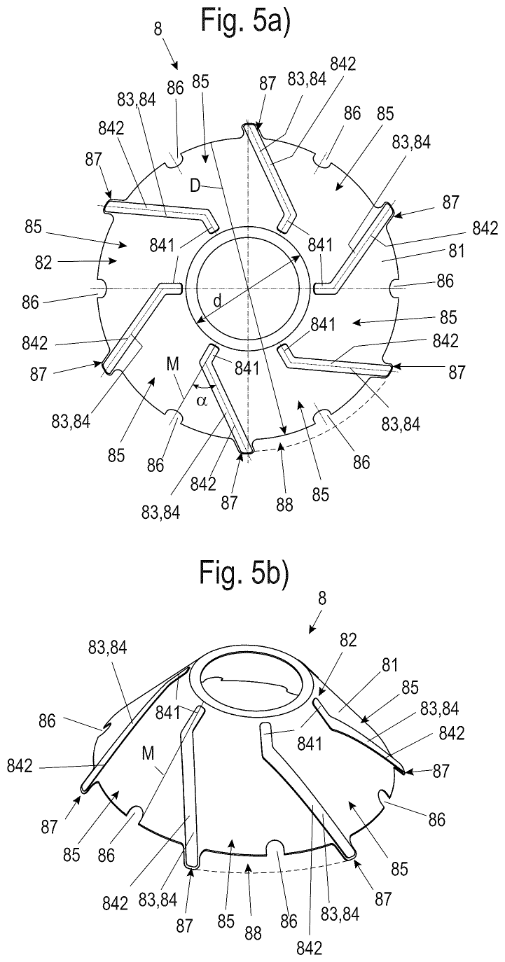

FIG. 5a and FIG. 5b show a further embodiment variant of a separation disc 8 according to the invention. In this variant, too, the spacers 83 in the form of tabs 84 are applied to the outer surface 82 of the main body 81 of the separation disc 8 at an equal pitch on the circumference of the main body 81 of the separation disc 8.

Deviating from the embodiment variant according to FIG. 2a and FIG. 2b, the spacers 83 in the form of tabs 84 are in each case arranged starting from the small diameter d of the main body 81 of the separation disc 8 here in the first section 841 initially along or parallel to the surface line M, in order to extend here after this first section 841 in the second section 842 arranged at an angle α to the surface line M further to the large diameter D of the main body 81 of the separation disc 8.

The tabs 84 are distributed here—analogous to the embodiment variant according to FIG. 2a and FIG. 2b—in a uniform pitch on the circumference of the main body 81, here on the outer surface 82 of the main body 81.

According to the exemplary embodiment according to FIG. 5a and FIG. 5b, it may be provided that the projections 87 are arranged at an angle α to the surface line M. In the region of the projection 87, the respective tab 84 follows the angular orientation of the projection 87, so that the second section 842 of the respective tab 84 extends in line with the projection 87.

The respective projection 87 has the same conical angle relative to the axial axis of the separation disc as the frustoconical shell-like main body 81 of the separation disc 8.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

1 Drum
2 Centrifuge
3 Lower part
4 Upper part
5 Piston slide
6 Drum interior
7 Separation disc stack
8 Separation disc
81 Main body
82 Outer surface
83 Spacer
84 Tab
841 Section
842 Section
85 Gap
86 Cutout
87 Projection
88 Segment-like zone
9 Distributor shaft
10 Distributor
11 Feed pipe
12 Distribution channel
13 Paring disc
14 Outlet opening
15 Paring disc chamber
16 Solids chamber
17 Riser channel
A Axis of rotation
D Diameter
d Diameter
L1 Liquid phases
M Surface line
R₁ Radius
R_{FR} Distance
α Angle
β Complementary angle

1-25. (canceled)

26. A separation disc for a centrifuge, which is a separator, wherein the separation disc comprises:
a frustoconical shell-like main body having a smaller diameter and a larger diameter, wherein the main body includes an inner surface and an outer surface, and the main body includes at least one or more spacers,
wherein radial outer projections are arranged circumferentially distributed on the larger diameter of the main body in a region of the one or more spacers, and wherein respective ones of the radial outer projections are arranged in a line or in extension of the outer surface of the main body, and
wherein the separation disc is configured to be arranged in a separation disc stack in a drum interior of a drum of the centrifuge to clarify or separate a mixture of substances.

27. The separation disc of claim 26, wherein the radial outer projections on a circumference of the main body of the separation disc in a region of the larger diameter are arranged with a same pitch as an arrangement of the one or more spacers on the separation disc.

28. The separation disc of claim 26, wherein the radial outer projections have a same taper angle relative to an axial axis of the separation disc as the main body.

29. The separation disc of claim 26, wherein segment-like zones are formed by the radial outer projections in a region of the larger diameter of the main body in each case between respective ones of the radial outer projections.

30. The separation disc of claim 26, wherein cutouts are arranged circumferentially distributed on the larger diameter of the main body.

31. The separation disc of claim 30, wherein the cutouts on the circumference of the main body are made at a uniform pitch.

32. The separation disc of claim 31, wherein the cutouts are each located in a middle, in a right-hand region, or in a left-hand region of the respective segment-like zone.

33. The separation disc of claim 26, wherein each spacer of the one or more spacers has a continuous length corresponding to a sum of a length of a surface line on the outer surface of the main body plus a length of a respective one of the radial outer projections.

34. The separation disc of claim 33, wherein the one or more spacers are arranged in a form of tabs at an angle to the surface line.

35. The separation disc of claim 34, wherein an amount of the angle to the surface line is between 10° and 60°.

36. The separation disc of claim 35, wherein the radial outer projections are arranged at the angle to the surface line.

37. The separation disc of claim 36, wherein, in a region of the respective ones of the radial outer projections, projection, the respective tab follows an angular orientation of the respective projection so that the respective tab extends in a line with the respective projection.

38. The separation disc of claim 37, wherein the respective tab is configured to be angled by a complementary angle of the angle to the surface line so that the respective tab has a first section and a second section.

39. The separation disc of claim 38, wherein, in the region of the respective projection, the respective tab follows the angular orientation of the projection so that the second section of the respective tab extends in a line with the projection.

40. The separation disc of claim 39, wherein the radial outer projections are integrally formed on the main body or are attached to the main body by a joining process.

41. The separation disc of claim 26, wherein the main body of the separation disc is produced by a spinning process.

42. The separation disc of claim 26, wherein the main body of the separation disc is made of a metallic material.

43. The separation disc of claim 26, wherein the separation disc has a driver geometry on the smaller diameter of the main body.

44. The separation disc of claim 26, wherein a cross-sectional geometry of the one or spacers is rectangular, trapezoidal rectangular, rectangular with rounded corners, semi-elliptical, or semi-oval.

45. The separation disc of claim 26, wherein the one or more the spacers are spaced apart by respective equal gaps between the one or more spacers.

46. A separation disc stack for a centrifuge, which is separator, wherein the separation disc stack comprises:
a plurality of separation discs, each of the plurality of separation discs comprising
a frustoconical shell-like main body having a smaller diameter and a larger diameter, wherein the main body includes an inner surface and an outer surface, and the main body includes at least one or more spacers,
wherein radial outer projections are arranged circumferentially distributed on the larger diameter of the main body in a region of the one or more spacers, and wherein respective ones of the radial outer projections are arranged in a line or in extension of the outer surface of the main body, and
wherein the separation disc stack is configured to be arranged in a drum interior of a drum of the centrifuge to clarify or separate a mixture of substances.

47. The separation disc stack of claim 46, wherein cutouts are arranged circumferentially distributed on the larger diameter of the main body of each of the plurality of separation discs, wherein the cutouts each form a riser channel.

48. The separation disc stack of claim 46, wherein segment-like zones are formed by the radial outer projections in a region of the larger diameter of the main body in each case between respective ones of the radial outer projections, wherein segment-like channels are formed by superimposed segment-like zones of the plurality of separation discs parallel to an axis of the centrifuge.

49. A centrifuge, which is separator or solid drum screw centrifuge, comprising:
a separation disc stack having a plurality of separation discs; and
a drum of the centrifuge having a drum interior, wherein the separation disc stack is arranged in the interior of the drum,
wherein each of the plurality of separation discs comprises
a frustoconical shell-like main body having a smaller diameter and a larger diameter, wherein the main body includes an inner surface and an outer surface, and the main body includes at least one or more spacers,
wherein radial outer projections are arranged circumferentially distributed on the larger diameter of the main body in a region of the one or more spacers, and wherein respective ones of the radial outer projections are arranged in a line or in extension of the outer surface of the main body.

50. The centrifuge of claim 49, wherein the radial outer projections project into a solids chamber of the drum by 25% to 75% with respect to a distance between a radius of the main body of the separation disc without projection and an outer diameter of the solids chamber of the drum in a region of the separation disc stack.
